(19) United States
(12) Patent Application Publication
(10) Pub. No.: US 2024/0287848 A1
(43) Pub. Date: Aug. 29, 2024

(54) MULTIFUNCTIONAL BUILDING WALL MODULE SYSTEM

(71) Applicant: Inventio AG, Hergiswil (CH)

(72) Inventors: Jonas Vonaesch, Luzern (CH); Christian Schulz, Zug (CH); Florian Trosch, Erlenbach ZH (CH)

(21) Appl. No.: 18/573,479

(22) PCT Filed: Jun. 8, 2022
(86) PCT No.: PCT/EP2022/065576

§ 371 Date: Dec. 22, 2023

(30) Foreign Application Priority Data
Jun. 30, 2021 (EP) 21182803.3

(51) Int. Cl. E06B 1/52

(52) U.S. Cl. CPC E06B 1/52

(57) ABSTRACT

A building wall module system has a frame structure that includes a wall side region, a wall shell region, a through-passage region between the wall side region and the wall shell region, and a guide track system that extends above the through-passage region. In an application in which a sliding door is inserted into the frame structure, the guide track system displaces the sliding door between a closed position, in which the sliding door closes the through-passage region, and an open position, in which the sliding door completely or partially frees the through-passage region. If a use with the sliding door is not required, a casing insert can be inserted into the through-passage region. The casing insert has connecting elements which, in the inserted state, connect it to the frame structure and which release it during removal from the frame structure.

### FIELD

The technology described herein relates in general to the technical equipment of a building. Exemplary embodiments of the technology relate in particular to a building wall module system and a method for adapting such a building wall module system to a building.

### BACKGROUND

Buildings can be fitted out in a wide variety of ways in order to define interior spaces or regions in a building floor plan or their use. Here, it is also possible to specify how persons are granted or denied access to the building or to interior spaces, for example through doors, locks or barriers. It is known, for example, to install a door frame (door casing) at an intended location, and to insert a door therein, when constructing a building wall that is made from masonry, is concreted, and/or is produced in drywall construction (e.g. a wood and/or metal structure in combination with gypsum plaster boards). In such a door system, the door can be designed as a swing door comprising a movable door leaf which is rotatably fastened to the door frame (casing, door lining) by two or more hinges (door hinges), or as a folding door in which one or more door leaves are divided by hinge bands or flexible strips into several parts which fold out of the closing plane during opening. Door systems comprising sliding doors are also known, which doors are fastened to the frame by runner rails in which the door leaf is hung or inserted and can be displaced laterally. EP 2 876 241 A1 describes, for example, a sliding door system in which a sliding door is displaceable within a frame structure between a closed position and an open position. In the closed position, the sliding door is flush with the wall surrounding it, and in the open position, a recess in the wall receives the sliding door at least partially.

In conjunction with the aforementioned door systems, the division of the interior spaces or regions is specified, and can often be changed only with significant effort. Over time, however, the requirements made of the interior spaces, the door system and/or the lifestyle habits or conditions of life of the occupants may change. There is therefore a need for a technology to adapt technical building equipment to such changes with little technical effort.

### SUMMARY

One aspect of the technology relates to a building wall module system which has a frame structure of fixed width, height and depth, which has a first strut structure extending in a first plane, and a second strut structure extending in a second plane which is essentially in parallel with the first plane and at a specified distance from this plane in the depth direction, as a result of which a free space exists between the two planes. A wall side region, a wall shell region and a through-passage region existing between the wall side region and the wall shell region are specified in the frame structure, and a guide rail system which extends above the through-passage region is arranged in the frame structure. On the two strut structures, a first lateral closing profile pair is arranged on the wall side region, adjacently to the through-passage region, and a second lateral closing profile pair is arranged on the wall shell region, adjacently to the through-passage region. In addition, an upper closing profile pair is arranged on the two strut structures, which profile pair connects the first and the second lateral closing profile pairs, essentially at right angles. These closing profile pairs surround the through-passage region. The second lateral closing profile pair and the upper closing profile pair each have a passage for a sliding door which is expandable in the depth direction. A guide rail of the guide rail system is arranged in an upper region of the frame structure and extends essentially in parallel with the upper closing profile pair. The guide rail is designed to store the sliding door between a closed position, in which the sliding door closes the through-passage region and presses against the closing profile pair, and an open position, in which the sliding door completely or partially releases the through-passage region and is at least partially displaced via the passage into the wall shell region. The building wall module system also comprises a casing insert which has connecting elements which connect the casing insert, inserted into the through-passage region, to the frame structure, and which, when the inserted casing insert is removed, release the casing insert from the frame structure.

Another aspect relates to a method for adapting a building wall module system as required, which system has a frame structure installed in a building, the structure having a fixed width, height and depth, and which is provided for use with a sliding door which can be expanded in the depth direction. A wall side region, a wall shell region and a through-passage region between the wall side region and the wall shell region are determined in the frame structure. Furthermore, a guide rail system for the sliding door is arranged therein, which system extends above the through-passage region. A first lateral closing profile pair is arranged on the wall side region, adjacent to the through-passage region, and a second lateral closing profile pair is arranged on the wall shell region, adjacent to the through-passage region. In addition, an upper closing profile pair is arranged on the frame system, which upper closing profile pair connects the first and the second lateral closing profile pairs essentially at a right angle; the closing profile pairs surround the through-passage region. The second lateral closing profile pair and the upper closing profile pair each have a passage for the sliding door. According to the method, a casing insert is provided, which is to be inserted into the through-passage region and is to be connected from there to the frame structure. The casing insert comprises a plurality of sub-components which each have at least one connecting element, by means of which the respective sub-component can be connected to the frame structure, after its positioning in relation to one of the closing profile pairs mentioned, a sequence being specified for the positioning and connecting. The sub-components are inserted and connected in accordance with the specified sequence.

The technology described here creates a building wall module system which is to be adapted as required to requirements for the use of rooms and/or the circumstances of life of the occupants, which change over time. The frame structure is prepared for an application in which a sliding door is inserted into the frame structure and used, and can be installed as such in the building. A guide rail system is already arranged in the frame structure, for example, by means of which system an inserted sliding door can be displaced between a closed position and an open position. For different reasons, however, it may be desirable to use the building wall module system without such a sliding door. In this case, a casing insert which is designed for a specified application can be inserted into the through-passage region. In this case, the sliding door can be stowed in the wall shell region and can be put out of operation; however, the sliding door can also be used only when required. The described technology thus offers the choice of using the building wall module system with a sliding door or with a casing insert.

Regardless of whether the sliding door is stowed in the wall shell region or is only inserted as required, the inserted casing insert covers the frame structure in the through-passage region. On both sides of the frame structure, wall panels are arranged, which clad the frame structure in accordance with its (spatial) environment. The frame structure, which is accessible or visible from the through-passage region, is concealed by the casing insert. The frame structure clad in this way is not visible to an observer.

According to the technology described here, not only is it possible to select whether the building wall module system is to be used with a sliding door or with a casing insert, but the type of the casing insert can also be selected. By way of example, according to this description a through-passage insert, a pass-through insert, a shelving insert, a swing door insert, a sliding door insert, a wall insert, and a hatch insert can be selected.

In at least some of the exemplary embodiments mentioned in this description, it is an advantage that an inserted casing insert can be removed again without the frame structure being damaged in the process. The casing insert is, for example, connected to the frame structure by connecting elements proceeding from the free space of the frame structure. The connecting elements are thus not visible from the outside and do not interfere with the appearance of the building wall module system or the casing insert. The connecting elements are moreover in particular releasable (e.g. can be screwed, clamped, tensioned and/or plugged). A choice made can thus be reversed again without damage to the building wall module system occurring in the process, which would then possibly have to be eliminated with significant effort.

In one exemplary embodiment, the casing insert has a first frame element which can be inserted at the first lateral closing profile pair, a second frame element which can be inserted at the second lateral closing profile pair, and a third frame element which can be inserted at the upper closing profile pair. Each frame element has at least one connecting element. The frame elements can be connected to the frame structure by means of these connecting elements. These connecting elements are designed such that they can be connected to the frame structure proceeding from the free space of the frame structure, in particular these connections are releasable, so that the frame elements can be removed again from the frame structure. Such a multi-part casing insert has the advantage that installation of the casing insert is facilitated.

In one exemplary embodiment, the casing insert is designed as a through-passage insert. The first, second and third frame elements together form a facing frame which has an outer surface which surrounds the through-passage region in the inserted state of the casing insert, along the closing profile pairs, and in this case covers each closing profile pair, at least towards the through-passage region. The outer surface of the facing frame is essentially flat. Such a through-passage insert conceals the frame structure which would be accessible or visible from the through-passage region. In addition, for such a through-passage insert, for example the material and the color design can be selected such that they are adapted to the spatial environment of the building wall module system.

In another exemplary embodiment, the casing insert is designed as a pass-through insert. The casing insert has a hatch and a wall part which, in the inserted state of the casing insert, fills the through-passage region outside the pass-through. The wall part has a cross-member arranged at a specified height, a base element, and vertical struts which extend between the base element and the cross-member in two essentially parallel planes which correspond to those of the strut structures. Such a pass-through insert fulfills a dual function: on the one hand, it creates a pass-through, i.e. an opening in a wall, through which things can be passed, and on the other hand, it closes the through-passage region outside the pass-through by adapting the wall part to the building wall module system, in particular to its depth. A person skilled in the art will recognize that a needs-appropriate size and position (for example height) can be selected for the pass-through. In addition, the pass-through insert also covers the frame structure in the above-mentioned manner; this property also applies to the exemplary embodiments mentioned below.

According to a further exemplary embodiment, the casing insert is designed as a shelving insert. The casing insert has a rear wall and at least one shelf. When the casing insert is inserted into the building wall module system, the rear wall will be connected to the first, second and third casing elements, and the at least one shelf will be accessible from a side opposite the rear wall. In the inserted state, the casing insert closes the through-passage region. A shelving insert prepared in this way can be designed flexibly, for example by the number and the arrangement of the shelves. A person skilled in the art will also recognize that the shelving insert can be more or less concealed or closed at its front side, for example by a door, a roller blind or a curtain.

According to another exemplary embodiment, the casing insert is designed as a swing door insert. The casing insert comprises a swing door and fittings. In the installed state of the casing insert, the swing door is pivotably connected to one of the lateral casing elements by means of the fittings. Such a swing door can be opened and closed in a known manner, and in the process release or block the through-passage region. There is flexibility with regard to the direction in which the swing door can be pivoted, since the fittings can be arranged either on the side of the wall shell region or on the side of the wall side region. A person skilled in the art will also recognize that the swing door insert is equipped with a closing device.

In a further exemplary embodiment, the casing insert is designed as a sliding door insert. The casing insert comprises a sliding door, i.e. a horizontally displaceable sliding door consisting of a single door leaf. In comparison with an expandable sliding door, for which the frame structure is prepared, the sliding door is simpler in design, in particular because it is not expandable, and therefore is also more cost-effective. For such a standard sliding door, the second lateral casing element has a vertical feedthrough, through which it can be guided into the wall shell region, between the two strut structures. The third casing element has a horizontal feedthrough, through which the standard sliding door can be connected to the guide rail system and along which the standard sliding door is displaceable.

In another exemplary embodiment, the casing insert is designed as a wall insert. In the inserted state of the casing insert, it fills the through-passage region essentially completely and closes it. The casing insert has vertical struts, stiffening elements, and a base profile. In the inserted state of the casing insert between the base profile and the upper closing profile pair, the vertical struts extend in two essentially parallel planes which correspond to those of the strut structures. The wall insert thus has a depth which corresponds to the depth of the frame structure. The wall insert can be clad in such a way that it is adapted to the cladding of the frame structure; depending on the type and extent, this adaptation may not be visible as such on the wall insert.

Also in the case of this casing insert designed as a wall insert, it is advantageous that it can be connected to the frame structure towards the inside of the frame structure. For this purpose, the casing insert has stiffening elements, for example, which laterally adjoin the frame structure. These (adjacent) stiffening elements have flanges via which the adjacent stiffening elements can be connected to the frame structure. The base profile also has flanges at its lateral ends, via which the ends can be connected to the frame structure. The vertical struts can be connected at their lower ends to the base profile and at their upper ends to the upper closing profile pair or, in the surroundings thereof, to the frame structure.

According to a further exemplary embodiment, the casing insert is designed as a hatch insert. The casing insert has a wall part and a hatch. The hatch has an open state in which an opening in the wall part and thus a part of the through-passage region is open, and a closed state in which the opening is blocked. In the inserted state and in the closed state of the hatch, the casing insert essentially entirely fills the through-passage region. In comparison with the above-mentioned swivel door and the sliding door, the hatch does not allow a person to pass through; instead, it is dimensioned such that relatively small objects (e.g. pets, autonomously moving devices (robots, drones)) can pass through. A person skilled in the art will recognize that a size and position (for example height) as is needed can be selected for the hatch. For pets and robots (e.g. robotic vacuum cleaners), the hatch is arranged close to the floor.

The hatch can be designed in various ways. In one exemplary embodiment, the hatch can be designed as a horizontally or vertically displaceable sliding hatch. In one exemplary embodiment, this sliding hatch can be equipped with a drive and a sensor system that automatically opens the hatch when e.g. a pet approaches, and closes it again when the pet has moved on. For this functionality, the sensor system and an information carrier worn by the pet can be equipped according to a contactless communication technology (e.g. RFID radio technology). In another exemplary embodiment, the hatch can be designed as a horizontally or vertically pivotable flap which can be locked and for example, in the unlocked state can be pushed away by the pet or robot.

The building wall module system can be used instead of a conventional building wall. The building wall module system is therefore designed, with regard to load-bearing capacity (e.g. when used as a supporting wall), fire protection, sound protection or sound insulation, thermal insulation, and intrusion protection, such that it has properties which, depending upon the use and the building, substantially correspond to those of a conventional building wall. For this purpose, not only the free space in the frame structure but also the swing door, the sliding door and the respective wall parts of the pass-through insert, the wall insert and the hatch insert can be equipped with fire protection, insulation, smoke protection, intrusion protection and/or sound protection material.

### DESCRIPTION OF THE DRAWINGS

Various aspects of the improved technology are described in greater detail below in conjunction with the drawings with reference to exemplary embodiments. In the figures, identical elements have identical reference signs. In the drawings:

FIG. 1A is a schematic side view of an exemplary embodiment of a frame structure of a building wall module system in which a sliding door can be inserted;

FIG. 1B is a schematic view of a horizontal cross-section through the frame structure shown in FIG. 1A;

FIG. 1C is a schematic perspective view of the frame structure shown in FIG. 1A;

FIGS. 1D-1H are schematic views of a horizontal cross-section through a sliding door and show its mode of operation in the frame structure shown in FIG. 1A;

FIG. 2A is a schematic perspective view of an exemplary embodiment of a frame structure having a casing insert designed as a through-passage insert;

FIGS. 2B-2D are schematic views of an exemplary embodiment of the casing insert shown in FIG. 2A;

FIGS. 2E-2H are schematic views of a further exemplary embodiment of the casing insert shown in FIG. 2A;

FIG. 3A is a schematic side view of an exemplary embodiment of a frame structure having a casing insert which is designed as a pass-through insert;

FIGS. 3B-3D are schematic views of an exemplary embodiment of the casing insert shown in FIG. 3A;

FIG. 4A is a schematic side view of an exemplary embodiment of a frame structure having a casing insert which is designed as a shelving insert;

FIGS. 4B-4D are schematic views of an exemplary embodiment of the casing insert shown in FIG. 4A;

FIG. 5A is a schematic perspective view of an exemplary embodiment of a frame structure having a casing insert designed as a swing door insert;

FIGS. 5B-5D are schematic views of an exemplary embodiment of the casing insert shown in FIG. 5A;

FIG. 6A is a schematic perspective view of an exemplary embodiment of a frame structure having a casing insert which is designed as a sliding door insert;

FIGS. 6B-6E are schematic views of an exemplary embodiment of the casing insert shown in FIG. 6A;

FIG. 7A is a schematic side view of an exemplary embodiment of a frame structure having a casing insert designed as a wall insert;

FIGS. 7B-7E are schematic views of an exemplary embodiment of the casing insert shown in FIG. 7A;

FIG. 8A is a schematic side view of an exemplary embodiment of a frame structure having a casing insert designed as a hatch insert;

FIGS. 8B-8E are schematic views of an exemplary embodiment of the casing insert shown in FIG. 8A; and

FIG. 9 is a flowchart of an exemplary embodiment of a method for adapting the building wall module to a building.

### DETAILED DESCRIPTION

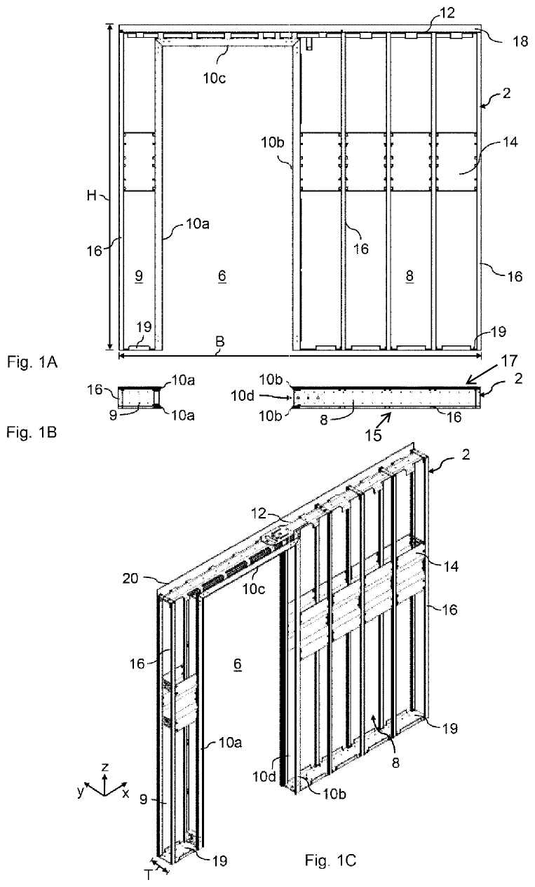

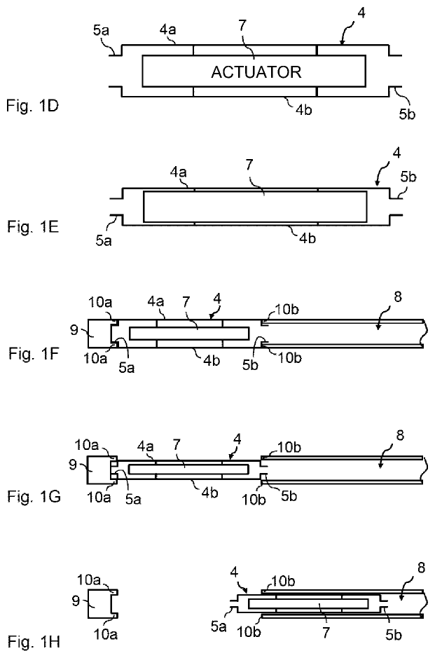

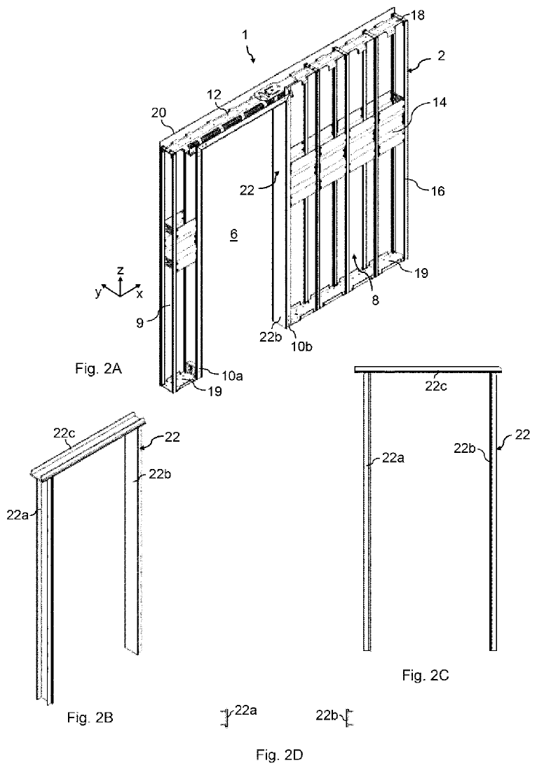

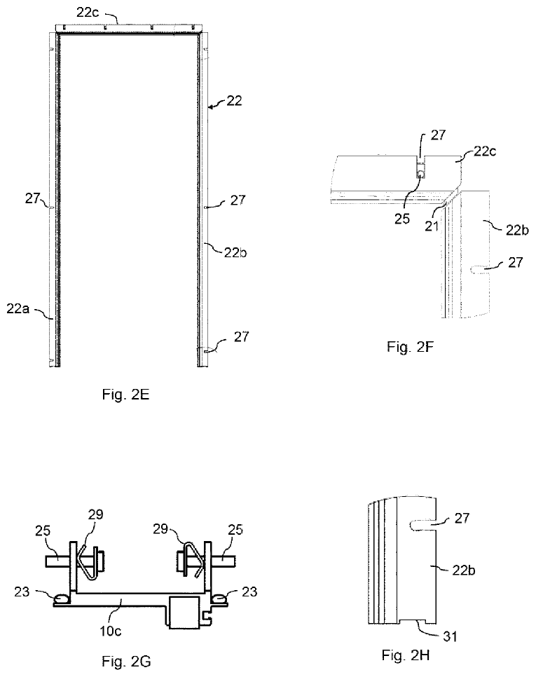

FIGS. 1A, 1B and 1C show an exemplary embodiment of a frame structure 2 of a building wall system 1 (see FIG. 2A), which can be used in various applications in accordance with the technology described here. In one exemplary embodiment of the building wall module system 1, a sliding door 4 can be inserted into the frame structure 2; FIGS. 1D-1H are schematic views of a horizontal cross-section through the sliding door 4 and show its mode of operation in the frame structure 2. Further exemplary embodiments of a building wall module system 1 are shown in connection with FIGS. 2A-8.

The building wall module system 1 is designed to be used in a building, instead of a building wall constructed from masonry, concreted, and/or produced in drywall construction (e.g. a wood, plastics, composite material, and/or metal construction in combination with, e.g. gypsum plaster boards). Such types of construction are known to a person skilled in the art. In relation to the x-y-z coordinate system shown in FIG. 1C, the building wall module system 1 has a width B in the x direction, a depth T in the y direction, and a height H in the z direction; the building wall module system 1 extends in a plane which is spanned by the x and z axes. In this case, the building wall module system 1 is inserted essentially vertically (upright); terms used in this description such as “vertical”, “horizontal”, “upper”, “lower”, “floor” or the like therefore refer to the installed building wall module system 1.

In one exemplary embodiment, the building wall module system 1 can be installed in or instead of a building interior wall, for example it can separate the private interior of an apartment from a (non-private or semi-private) external region (e.g. hallway or stairwell) in an apartment building. In such an apartment or in a single-family house, the building wall module system 1 can also be used to separate interior spaces. Similarly, the building wall module system 1 can be used, for example, as a building interior wall in an office building, hotel, or the like; in a hotel, the building wall module system 1 can also separate two adjacent rooms, for example. In another exemplary embodiment, the building wall module system 1 can be a building exterior wall, for example it can separate the interior region of a non-public building (e.g. a residential building, hotel, business building, or the like) from the public exterior region (e.g. a road or a public space). A person skilled in the art will recognize that the technology described herein is not limited to one specific application.

In the exemplary embodiment shown, the frame structure 2 has an upper cross-member 18, a plurality of base profiles 19, struts 16, stiffening elements 14, closing profiles 10a, 10b, 10c, and a guide rail system 12. The struts 16 extend essentially vertically between the upper cross-member 18 and the base profiles 19, and the stiffening elements 14 are fastened to the struts 16. As shown by way of example in FIG. 1C, a base profile 19 can be designed as a U-shaped profile having a base plate and lateral tabs. The base profile 19 has a depth which is selected according to the depth T of the building wall module system 1. Two struts 16 in each case are fastened opposite one another to a base profile 19 and to the upper cross-member 18, a distance between the two struts 16 resulting from the depth of the base profile 19. The stiffening elements 14 connect adjacent pairs of struts 16. As shown in FIG. 1B, the struts 16 and the connected stiffening elements 14 extending in a first plane form a first strut structure 15 and the struts 16 and the connected stiffening members 14 extending in a second plane form a second strut structure 17 parallel to and spaced from the first strut structure 15 in the direction of the depth T.

As shown in FIG. 1A, the frame structure 2 has a through-passage region 6, a wall shell region 8 and a wall side region 9, the through-passage region 6 being arranged between the wall shell region 8 and the wall side region 9. In the installed state, the wall shell region 8 and the wall side region 9 (on the side facing away from the through-passage region 6) are connected to the remainder of the building. The closing profiles 10a, 10b, 10c surround the through-passage region 6, two closing profiles 10a being arranged vertically on the wall side region 9, and two closing profiles 10b being arranged vertically on the wall shell region 8; two horizontal closing profiles 10c are directly or indirectly connected to the cross-member 18 and connect the closing profiles 10a, 10b to one another. The closing profiles 10a, 10b are connected by the stiffening elements 14 to adjacent struts 16.

To illustrate that the frame structure 2 is clad (covered) in the installed state, FIG. 1C shows a wall panel 20 on one side of the frame structure 2, which is fastened to the frame structure 2. The wall panel 20 covers the wall shell region 8, the wall side region 9 and a surface above the through-passage region 6. A person skilled in the art will recognize that the wall panel 20 can be composed of individual panels, and that the frame structure 2 can be clad on both sides. With such a cladding, there is a cavity between the wall panels 20 in the wall shell region 8, and a cavity in the wall side region 9, which cavities are visible in FIG. 1B and FIG. 1C. In one exemplary embodiment, the through-passage region 6 is designed and dimensioned such that a person can pass through it in order to pass from one side of the building wall module system 1 to the other side. The wall shell region 8 is designed and dimensioned to completely or partially receive a sliding door 4 inserted in its interior (cavity), which is the case in an open position of the sliding door 4. A passage 10d is provided for this purpose between the closing profiles 10b. A person skilled in the art will recognize that the dimensions of the building wall module system 1, and in particular its height H and width B, can be adapted to building-specific specifications. For the through-passage region 6, standard widths or minimum widths can be specified, depending on the building. Since the wall shell region 8 essentially entirely receives the sliding door 4 in the open position, a minimum width of the wall shell region 8 is thus also specified.

The frame structure 2 can be used in conjunction with a sliding door 4. The basic structure and functionality thereof are described by way of example in FIG. 1D-FIG. 1H (these each show horizontal cross-sections through the sliding door 4 and/or the frame structure 2). The sliding door 4 has two door leaves 4a, 4b and one actuator 7. In this exemplary embodiment, each door leaf 4a, 4b has two lateral flanges 5a, 5b and an upper flange. In the exemplary embodiment shown, the flanges are shown in each case as L-shaped angular profiles which point away from the respective door leaf 4a, 4b at right angles into the interior of the door. The actuator 7 is designed to move the door leaves 4a, 4b towards one another and away from one another; in FIG. 1D the door leaves 4a, 4b are at a greater distance from one another than in FIG. 1E.

FIG. 1F shows the sliding door 4 in a closed state. In this state, the actuator 7 has moved the door leaves 4a, 4b away from one another (FIG. 1D), the flange 5a engaging in the closing profiles 10a, and the flange 5b engaging in the closing profiles 10b. Due to the functionality of moving the door leaves 4a, 4b away from one another for this state, i.e. of expanding them, the sliding door 4 is expandable in the depth direction and in this description is inter alia also referred to as such (“expandable sliding door”).

FIG. 1G shows the sliding door 4 during a transition from the closed state into an open state (a similar situation results during closing). In this state, the actuator 7 pulls the door leaves 4a, 4b towards one another (FIG. 1E), the flange 5a being decoupled from the closing profiles 10a, the flange 5b being decoupled from the closing profiles 10b, and the upper flange being decoupled from the upper closing profiles 10c. FIG. 1H shows the sliding door 4 in the open state, it being located in part in the wall shell region 8. In order to displace the sliding door 4 back and forth between the closed state and the open state, in one exemplary embodiment the actuator 7 of the sliding door 4 is equipped as an electrical drive unit which is controlled by an access control system or a building management system. In one exemplary embodiment, the sliding door 4 is equipped with an electrical interface device, inter alia for communication with the access control system or building management system.

Proceeding from the frame structure 2 described in connection with FIGS. 1A—1H, various applications and embodiments of the building wall module system 1 are described in the following. These applications and embodiments illustrate that the building wall module system 1 can be adapted as required to changing requirements for the use of spaces, for example. As stated above, the frame structure 2 is prepared for use with the expandable sliding door 4, for example it can already be installed during the construction of the building. However, in the planning and construction phase of the building, an architect or builder may balk at the costs for the expandable sliding door 4 and/or the need for such a sliding door 4 in the building. As an alternative, in this case, a casing insert 22 (see FIG. 2A), which is designed for a specified application and is more cost-effective, for example, can be inserted into the through-passage region 6. Nevertheless, the possibility remains of using the building wall module system 1 together with an expandable sliding door 4 at a later point in time.

In a use shown by way of example in FIGS. 2A-2H, the building wall module system 1 creates a through-passage from one space into an adjacent space. As shown in FIG. 2A, the through-passage is freely passable, without a door needing to be opened, for example. The through-passage can, for example, also be referred to as a passageway or an archway. A sliding door 4, as shown in FIG. 1D-FIG. 1H, does not need to be inserted into the frame structure 2 in this application, but can be inserted if, for example, the building wall module system 1 has already been used with a sliding door 4 (instead of removing the sliding door 4), or if it is to be used at a later time with the sliding door 4. FIG. 2A is a schematic perspective view of an exemplary embodiment of the frame structure 2, which is equipped with a casing insert 22. FIG. 2B is a schematic perspective view of the casing insert 22, and FIG. 2C is a schematic side view of the casing insert 22, which has two vertical casing elements 22a, 22b and a horizontal casing element 22c, for example. FIG. 2D is a horizontal cross-section through the casing insert 22, the arrangement of the casing elements 22a, 22b with respect to the closing profiles 10a, 10b being visible in the cross-section. The casing elements 22a, 22b, 22c can, for example, be inserted individually into the frame structure 2 and connected thereto, for example they can be fastened (e.g. screwed) to the closing profiles 10a, 10b, 10c or in the vicinity thereof to the frame structure 2.

The casing insert 22 is dimensioned such that it can be inserted into the frame structure 2, adjoins the closing profiles 10a, 10b, 10c in the inserted state, and completely or partially covers it. In one exemplary embodiment, the dimensioning is selected such that the casing insert 22 completely or partially covers the installed and clad frame structure 2; depending on the degree of coverage, it may be more or less visible to an observer. Since the casing insert 22 can be inserted into the installed frame structure 2 (because a sliding door 4 has already been inserted or is to be inserted in the future), it can also be removable again from the frame structure 2 with relatively little effort.

In this case, the casing insert 22 is designed in such a way that it has properties that are specified in accordance with the building situation existing on site; for example, it can be adapted to the closer spatial environment of the building wall module system 1. The properties mentioned can relate, for example, to the material, the stability, the surface structure, the shaping and the coloring of the casing insert 22. The material may be metal, wood, plastics material, carbon fiber, glass fiber or a combination of these materials. In FIG. 2A and FIG. 2B the casing element 22b has, for example, an essentially smooth visible end face.

FIGS. 2E-2H show a further exemplary embodiment of a casing insert 22. In this exemplary embodiment, insertion and connection possibilities of the casing elements 22a, 22b, 22c are described. FIG. 2E is a schematic side view of the casing insert 22, a plurality of slots 27 in the casing elements 22a, 22b, 22c being shown. Details of an upper corner of the casing insert 22 (top right) are shown in a side view in FIG. 2F. A bolt element 25, hereinafter referred to as a bolt 25, projects through a slot 27 in the upper casing element 22c. The bolt 25 is fastened to the frame structure 22 at a specified location, for example on the upper closing profile 10c. A person skilled in the art will recognize that a bolt 25 projects through each slot 27 in the upper closing profile 10c. The locations at which the bolts 25 are fastened are specified in a construction plan of the frame structure 2. FIG. 2F in addition shows a corner connector 21 which projects from the casing element 22c essentially at right angles (relative to the longitudinal axis thereof) and points downwards. For this purpose, the (vertical) casing element 22b has a receptacle, into which the corner connector 21 can be inserted during assembly.

As shown in FIG. 2G in an enlarged view (cross-section perpendicular through the longitudinal axis of the closing profile 10c), each bolt 25 has a securing element 29 on an inner side of the upper closing profile 10c, as a result of which the upper closing profile 10c is connected to the frame structure 2. A person skilled in the art will recognize that the casing elements 22a, 22b are likewise connected to the frame structure 2 by such combinations consisting in each case of a bolt 25 and a securing element 29. As is shown by way of example in FIG. 2G, the securing element 29 can be designed as a compressible expansion clamp or clamping spring made of metal, which is placed on the bolt 25 prior to assembly. When a bolt 25 is inserted into a slot 27, the expansion clamp (29) 29 is compressed by the material of the respective casing element 22a, 22b, 22c surrounding the slot 27, and is thus secured against displacement. A person skilled in the art will recognize that this functionality can also be implemented by a different type of connecting element, for example a clamping ring, leaf spring or disk spring or the like. A person skilled in the art will also recognize that this type of connection makes it possible to remove a casing element 22a, 22b, 22c from the frame structure 2 again, for example it can be pulled out.

FIG. 2G also shows two spring elements 23 which rest on outer longitudinal edges of the closing profile 10c. The spring elements 23 are resilient elements made of plastic and/or metal, which can be compressed under pressure and, when the pressure is lowered or removed, relax again and essentially assume their original shape again. A spring element 23 can comprise, for example, one or more coil springs made of metal; for example, a plurality of individual spring elements 23 can be arranged one behind the other along the casing element 22c. In another exemplary embodiment, a spring element 23 can be made of plastic and have a structure which has the aforementioned resilient properties. A person skilled in the art will recognize that the mentioned embodiments of the spring element 23 are by way of example, and the spring elements 23 are not limited thereto.

FIG. 2H is a side view of an exemplary embodiment of a part of the casing element 22b close to the floor. At the end of the casing element 22b shown, a recess 31 is shown, into which a complementary counterpart of the frame structure 2 engages during assembly. A projecting rear part of the casing element 22b is “latched in” and can thus no longer be pulled forward. If the upper part is then clamped or screwed, the casing element 22b will be secured. This facilitates, for example, positioning of the casing element 22b, and secures the casing element 22b against being pulled out. A person skilled in the art will recognize that the casing element 22a can be designed analogously to the casing element 22b.

In order to insert the casing insert 22 into the frame structure 2 according to an exemplary embodiment, the upper casing element 22c can be inserted into the frame structure 2 first. This is effected by the slots 27 of the casing element 22c being aligned with the bolts 25 of the closing profile 10c, and the casing element 22c being pushed upwards, so that the bolts 25 enter the slots 27. The vertical casing element 22b is inserted in that its slots 27 are aligned with the bolts 25 of the closing profile 10b, for example the part close to the floor, shown in FIG. 2H, is positioned first, while the casing element 22b is held inclined in the through-passage region 6. The casing element 22c is then pressed upward, as a result of which the spring elements 23 are pressed against surfaces of the closing profile 10c and are pressed together in the process, so that the corner connector 21 can be positioned over the receptacle of the (now vertically standing) casing element 22b. If the casing element 22c is then released, the spring elements 23 relax and press the casing element 22c downwards, as a result of which the corner connector 21 is inserted into the receptacle. A person skilled in the art will recognize that the casing element 22a is inserted analogously thereto.

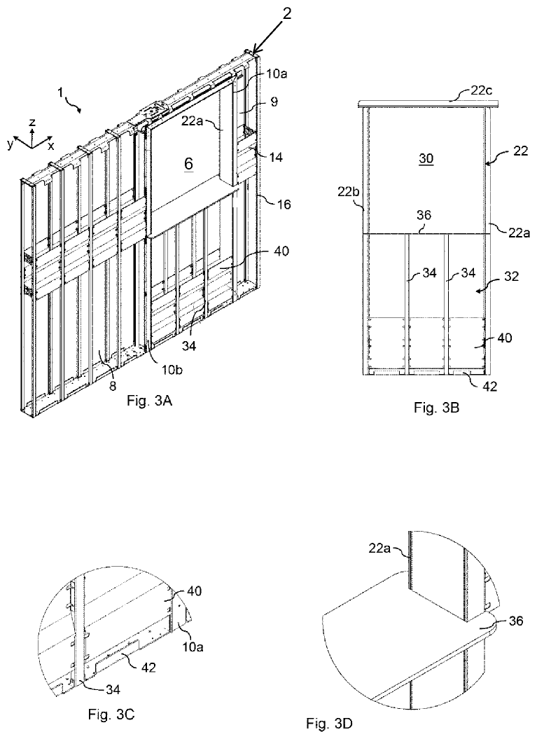

Likewise proceeding from the frame structure 2 described in conjunction with FIGS. 1A-1H, FIGS. 3A-3D show a further application, by way of example, of the building wall module system 1. In this application, a casing insert 22, which is designed as a pass-through insert, is inserted into the through-passage region 6. A pass-through is usually an opening in a wall through which things can be passed, for example food can be passed between a kitchen and a dining room, or medication between a sales space of a pharmacy and a public area in front of the pharmacy. Such a pass-through can be closed and opened in various ways (e.g. by means of a flap, a roller shutter or one or more doors); the pass-through insert 22 described here can also be designed in accordance with one of these types.

FIG. 3A is a schematic perspective view of an exemplary embodiment of the building wall module system 1, the casing insert 22 (pass-through insert) being inserted into the frame structure 2. FIG. 3B is a schematic side view of the exemplary casing insert 22. The casing insert 22 has a pass-through 30 and a wall part 32, the pass-through 30 essentially occupying an upper half of the casing insert 22, and the wall part 32 the lower half of the casing insert 22. A person skilled in the art will recognize that such a division ratio is by way of example, and that a different division ratio may be selected in another exemplary embodiment. A person skilled in the art will also recognize that the wall part 32 is also clad correspondingly with its spatial environment.

In one exemplary embodiment, the casing insert 22 can be constructed starting from the structure of the through-passage insert (see FIG. 2A-FIG. 2H), and have two vertical casing elements 22a, 22b and a horizontal casing element 22c. These can inserted into the frame structure 2 as described in conjunction with FIG. 2A-FIG. 2H, including the spring elements 23, bolts 25, slots 27 and securing elements 29 shown and described therein. In the example shown, the horizontal casing element 22c and the upper halves of the casing elements 22a, 22b delimit the hatch laterally and upwards. The wall part 32 delimits the pass-through 30 downwards.

The wall part 32 comprises at least one cross-member 36, a base element 42, and vertical struts 34. The cross-member 36 extends essentially horizontally between the casing elements 22a, 22b, at a height selected or specified for the pass-through 30, and the vertical struts 34 extend between the base element 42 and the cross-member 36. Similarly to the struts 16 of the frame structure 2, the struts 34 can also be arranged in pairs, and reinforcement elements 40 can be arranged between adjacent struts 34. A person skilled in the art will recognize that for example, the number of struts 34 and the number of reinforcement elements 40 can be selected according to the expected use of a room.

FIG. 3C is an enlarged view of the connection of a strut 34 to the adjacent reinforcement elements 40, and the connection of the strut 34 to the base element 42. These connections can be established using connection techniques known to a person skilled in the art (e.g. by means of screwing, riveting, welding, plugging and/or clamping).

The cross-member 36 has a width in the x direction and a depth in the y direction. The width can be selected such that it is either equal to the distance between the casing elements 22a, 22b, or is longer than the distance thereof by a specified value. In the latter case, the depth of the cross-member 36 can be larger than the depth of the pass-through 30, the cross-member 36 having a recess at each of its two longitudinal ends, in order to partially receive the respective casing element 22a, 22b alone or together with the respective closing profile 10a, 10b; FIG. 3D shows this by way of example in an enlarged view. A person skilled in the art will recognize that for example a shelf can be mounted on the cross-member 36 which (instead of the cross-member 36) is designed in a manner corresponding to that in the example shown in FIG. 3D. A person skilled in the art will also recognize that the cross-member 36 can be designed such that a shelf of this kind is integrated therein.

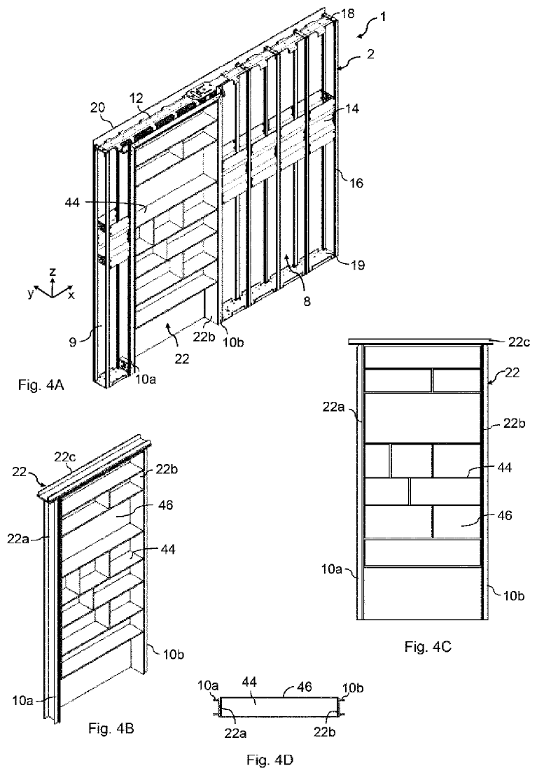

Again proceeding from the frame structure 2 described in conjunction with FIGS. 1A-1H, FIGS. 4A-4D show a further application, by way of example, of the building wall module system 1. In this application, a casing insert 22, which is designed as a shelving insert, is inserted into the through-passage region 6. In one exemplary embodiment, the shelving insert has a rear wall 46, so that adjacent spaces are visually separated. If an acoustic separation is also intended, the rear wall 46 can be designed according to acoustic aspects (for example shaping, thickness and/or mass). At least one shelf 44 can be inserted into the shelving insert, which shelf can be accessed from an access side of the shelving insert. If a plurality of shelves 44 is used, they can be inserted in a flexible manner; FIGS. 4A-4C show an exemplary embodiment for this. A person skilled in the art will recognize that the shelving insert can also be used without an inserted shelf 44 and/or the rear wall 46. A person skilled in the art will also recognize that the shelving insert can be designed on its access side in such a way that a door, a roller blind or a curtain can be attached there.

In one exemplary embodiment, the casing insert 22 can be constructed starting from the structure of the through-through-passage insert (see FIG. 2A-FIG. 2H), and have two vertical casing elements 22a, 22b and a horizontal casing element 22c. These can be inserted into the frame structure 2 as described in conjunction with FIG. 2A-FIG. 2H, including the spring elements 23, bolts 25, slots 27 and securing elements 29 shown and described therein. In addition, devices are present in the casing elements 22a, 22b, which enable the insertion of a shelf 44, for example holes which are applied according to a defined pattern and into which shelf pins can be inserted at the desired height. In another exemplary embodiment, the rear wall 46 can have devices for attaching a shelf 44. Devices for attaching shelves 44 are known to a person skilled in the art.

In the perspective view of FIG. 4B and the side view of FIG. 4C, the casing elements 22A, 22B are arranged and fastened as described in FIG. 2B and FIG. 2C. A horizontal cross-section through the shelving insert is shown in FIG. 4D.

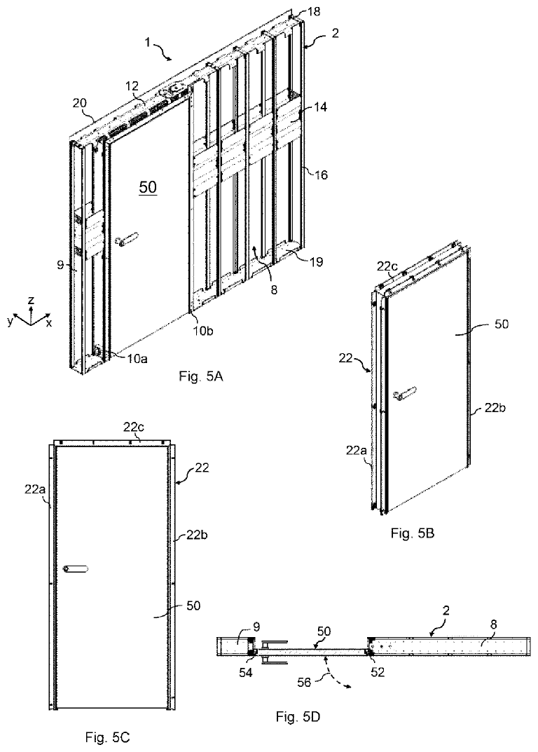

FIGS. 5A-5D show a further application, by way of example, of the building wall module system 1. In this application, a casing insert 22 is inserted into the through-passage region 6, which insert is designed as a swing door insert. The swing door insert comprises the casing elements 22a, 22b, 22c, a swing door 50, fittings 52, and a closing and locking mechanism 54. If the swing door 50 is fastened to the fittings 52, the swing door 50 can be opened in a specified direction, the fittings 52 serving as fixed points; this is indicated in the horizontal cross-section of FIG. 5D by a double-headed arrow 56. In FIG. 5D it can also be seen that the fittings 52 in this exemplary embodiment are arranged on the side of the wall shell region 8; at least parts of the closing and locking mechanism 54 are arranged opposite the wall shell region 8, in the frame structure 2.

In an exemplary embodiment, the two vertical casing elements 22a, 22b and the horizontal casing element 22c of the casing insert 22 can be inserted into the frame structure 2, as described in connection with FIG. 2E-FIG. 2H, including the spring elements 23, bolts 25, slots 27 and securing elements 29 shown and described therein. Due to its weight, the swing door 50 exerts a force on the fittings 52 and on the casing element 22b. A person skilled in the art will recognize that the casing element 22b is designed in accordance with this requirement; it can be secured, for example, by additional connections (e.g. screwed connections) in the frame structure 2; in one exemplary embodiment, it can also be anchored in the floor and/or in the ceiling.

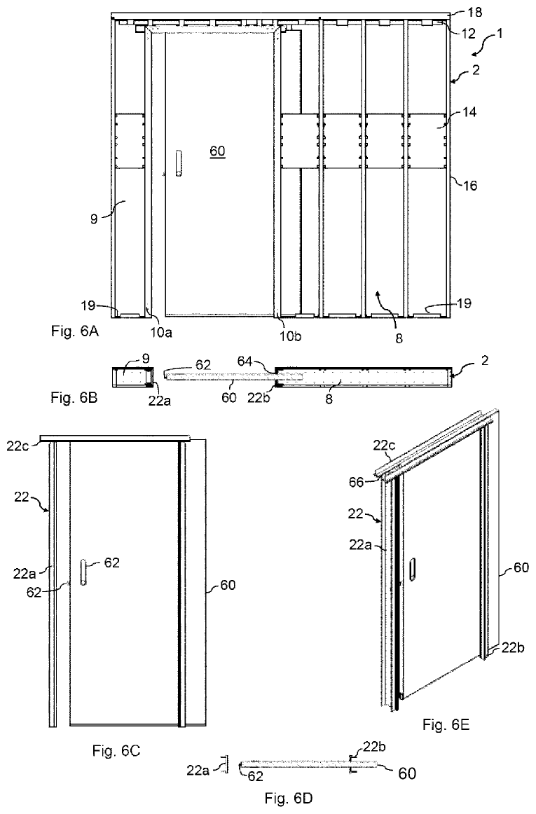

FIGS. 6A-6E show a further application, by way of example, of the building wall module system 1. In this application, a casing insert 22, which is designed as a sliding door insert, is inserted into the through-passage region 6. The sliding door insert comprises a sliding door 60, which, in conjunction with the sliding door 4 described in FIGS. 1D-1H, is designed as a simple, non-expandable sliding door; for better differentiation, the sliding door 60 is also referred to in the following as a “standard sliding door 60”. The standard sliding door 60 can be displaceable, for example, automatically or manually (with or without support by an electromechanical drive).

In the side view of the building wall module system 1 shown in FIG. 6A, the standard sliding door 60 is shown schematically in a partially open position. In this open position, a part of the standard sliding door 60 is located in the wall shell region 8, as is also shown in the horizontal cross-section through the building wall module system 1 shown in FIG. 6B. In the casing insert 22 (sliding door insert) according to the side view of FIG. 6C, the horizontal cross-section of FIG. 6D, and the perspective view of FIG. 6E, the standard sliding door 60 is also shown in the partially open position. In a fully open position, the standard sliding door 60 is essentially located in the wall shell region 8 (apart from a lateral handle/engagement by which the standard sliding door 60 can be displaced by a user).

The sliding door insert also comprises the casing elements 22a, 22b, 22c, at least the lateral casing element 22b and the upper casing element 22c being adapted to the use of the standard sliding door 60. The casing element 22b can, for example, be divided into two, so that there is a vertical opening 64 between the parts, through which the standard sliding door 60 can be displaced into the wall shell region 8; this is shown for example in FIG. 6B and FIG. 6D. The casing element 22b thus masks the gaps between the frame structure 2 and the standard sliding door 60 which are present on both sides of the standard sliding door 60.

The standard sliding door 60 has guide elements which are designed to match/be complementary to the guide rail system 12 provided in the frame structure 2. The standard sliding door 60 can be inserted into the guide rail system 12 by means of these guide elements. The casing element 22c can be designed in two parts so that a horizontal opening 66 exists between the parts, so that the guide elements or an upper part of the standard sliding door 60 can be displaced along this horizontal opening; this is shown for example in FIG. 6E. The casing element 22c therefore also masks gaps which exist along the horizontal opening, on both sides of the standard sliding door 60.

In the exemplary embodiment shown, the casing insert 22 also comprises a locking mechanism 62, which is shown for example in FIG. 6B and FIG. 6C. The locking mechanism 62 can have a latch which projects at an end face of the standard sliding door 60 and can be activated, for example, by a handle on the standard sliding door 60. The casing element 22a is designed in a corresponding manner. It has an opening, for example at the height of the latch, into which the latch engages when the standard sliding door 60 is closed.

In an exemplary embodiment, the two vertical casing elements 22a, 22b and the horizontal casing element 22c of the casing insert 22 can be inserted into the frame structure 2 as described in conjunction with FIG. 2E-FIG. 2H, irrespective of whether the casing elements 22b, 22c are formed in one piece or in two parts. The casing elements 22a, 22b, 22c can be inserted, for example, by means of the spring elements 23, bolts 25, slots 27 and securing elements 29 shown and described therein.

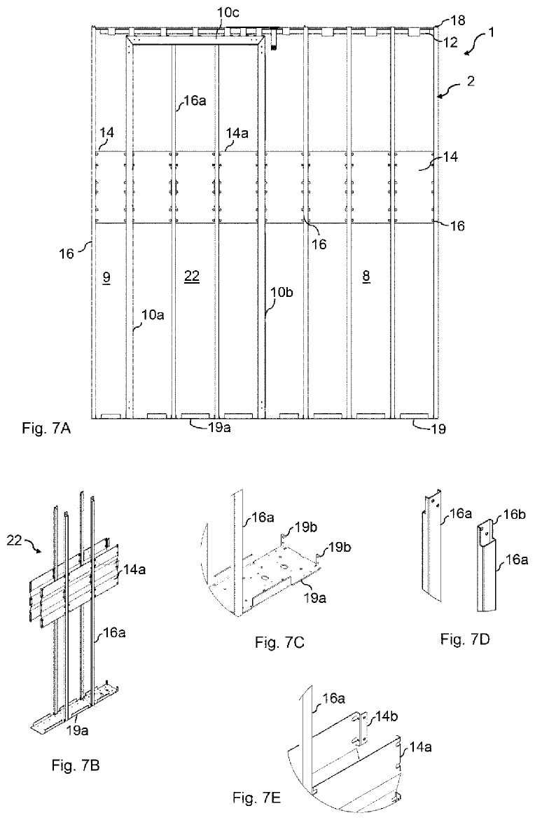

A further exemplary application, by way of example, of the building wall module system 1 is shown in FIGS. 7A-7E. In this application, a casing insert 22, which is designed as a wall insert, is inserted into the through-passage region 6. The wall insert fills the through-passage region 6 essentially entirely, and thereby closes it. FIG. 7A is a schematic side view of the building wall module 1, the casing insert 22 designed as a wall insert being inserted into the frame structure 2. The casing insert 22 comprises vertical struts 16a, stiffening elements 14a, and a base profile 19a. These parts of the casing insert 22 correspond in their basic functions and arrangements to those of the parts (14, 16, 19) which are described in conjunction with the frame structure 2, for example, in conjunction with FIG. 1C. The perspective view of the casing insert 22 in FIG. 7B shows, for example, the paired arrangement of the vertical struts 16a, and the connection of two adjacent vertical struts 16a by a stiffening element 14a. A person skilled in the art will recognize that, depending on the requirements made of the wall insert, further struts 16a and stiffening elements 14a may be provided in addition to the vertical struts 16a and stiffening elements 14a shown. A person skilled in the art will also recognize that the wall insert can be clad on both sides by wall panels (adapted to its surroundings).

FIG. 7C is an enlarged view showing that the vertical struts 16a are connected at their lower ends to the base profile 19a. The vertical struts 16a can be connected to the base profile 19a before the casing insert 22 is inserted. The vertical struts 16a can be screwed or welded to the base profile 19a, for example. FIG. 7C furthermore shows that the base profile 19a has at least one flange 19b, by which the floor profile 19a can be connected to the base profile 19 of the frame structure 2; the base profile 19 is designed in a corresponding manner for this. The base profile 19a can, for example, be screwed, welded, clamped and/or riveted to the base profile 19. In FIG. 7C two flanges 19b are shown by way of example. A person skilled in the art will recognize that the base profile 19a also has at least one such flange 19b at its other end. The base profile 19a can thus be connected at its two ends to the frame structure 2.

FIG. 7D is an enlarged view showing the upper ends of the vertical struts 16a. A flange 16b, which can be connected to the upper closing profile 10c, is present on each vertical strut 16a. The flange 16b is formed matching/complementary to the connecting surface specified on the closing profile 10c. The flange 16b has, for example, at least one hole, through which a screw or a bolt can be guided in order to connect the vertical strut 16a to the upper closing profile 10c. In the exemplary embodiment shown, the flange 16b has two holes. As a result of these connections, the casing insert 22 is connected to the frame structure 2 on its upper side in the installed state. A person skilled in the art will recognize that a different connection technique can be selected as an alternative to screws and holes.

FIG. 7E shows, in an enlarged view, lateral ends of the stiffening elements 14a, which are to be connected to the frame structure 2 or its vertical closing profiles 10a, 10b. A flange 14b is present on each of these stiffening elements 14a, which flange 14b can (here) be connected to the vertical closing profile 10b. The flange 14b is formed matching/complementary to the connecting surface specified on the closing profile 10b. The flange 14b has at least one hole, through which a screw or a bolt can be guided in order to connect the stiffening element 14a to the vertical closing profile 10b. In the exemplary embodiment shown, the flange 14b has two holes. As a result of these connections, the casing insert 22 is connected laterally to the frame structure 2 in the installed state.

If the wall insert is adapted to its surroundings in the installed state, for example clad accordingly, the wall insert may not be noticeable to an observer. The wall insert can be installed, for example, when a through-passage between adjacent spaces is not desired, or if a through-passage is no longer desired. If, in contrast, the wall insert is no longer desired at a later time, it can be removed again and the building wall module system 1 can be used according to another application specified in this description. In order to remove the wall insert, for example a plastered transition (joint) from the wall insert to its surroundings can be exposed. Next, one or more wall panels can be removed in order to obtain access to the struts 16a, the stiffening elements 14a and the base profile 19a, and to be able to remove them.

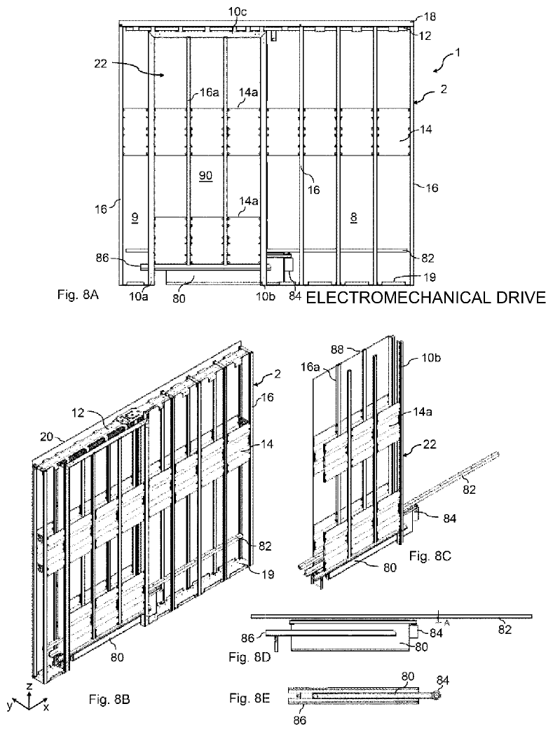

A further application, by way of example, of the building wall module system 1 is shown in FIGS. 8A-8E. In this application, a casing insert 22 is inserted into the through-passage region 6, which insert is designed as a hatch insert. The hatch insert is designed similarly to the wall insert described in conjunction with FIGS. 7A-7G, and therefore reference is made to the statements made therein with respect to the vertical struts 16a, the stiffening elements 14a and their connections to the frame structure 2. For example close to the floor, however, the hatch insert has a hatch 80 which can be opened or closed as required. The region surrounding the hatch 80 is referred to as a wall part 90. The hatch 80 can be, for example, a through-passage for a pet and/or an autonomously driving device (e.g. a vacuum cleaner robot or another type of robot). A person skilled in the art will recognize that the dimensions and the position of the through-passage can be specified according to the expected use (pet and/or robot).

In the exemplary embodiment shown, the hatch 80 is displaceable in the x direction; as such the hatch 80 can be regarded as if it were a smaller sliding door. In order to enable displaceability, a guide rail 82 of a guide rail system is arranged in the casing insert 22. As shown in the figures, the guide rail 82 is arranged essentially horizontally. The guide rail 82 extends from the interior of the casing insert 22 into the wall shell region 8. This makes it possible for the hatch 80 to be displaced completely or partially into the wall shell region 8, in the open state.

In one exemplary embodiment, the guide rail system has an electromechanical drive 84 which opens or closes the hatch 80 in response to a control signal. For this purpose, the guide rail system has a control device which supplies electrical energy to the electromechanical drive 84 and controls it. In another exemplary embodiment, the guide rail system can be connected to such a control device. The control device is preferably arranged in the casing insert 22, so that the casing insert 22 only needs to be connected to a power supply, in order to operate the hatch 80 automatically. The power supply can for example already be provided in the frame structure 2.

The control device can have a radio device which communicates with a radio device arranged on the pet or the robot. The radio devices can be designed, for example, according to RFID radio technology. If, for example, the pet is located within a radio range (or its radio device) specified for the hatch 80, the control device generates a control signal which causes the drive 84 to open the hatch 80. If the pet is located outside the radio range, the control device causes the hatch 80 to be closed. An analogous operation applies in the case of a robot.

In a deviation from the wall insert described in conjunction with FIGS. 7A-7G, the hatch insert has horizontal cross-members 86 in a lower region. The vertical struts 16a are connected at their lower ends to these horizontal cross-members 86. The cross-members 86 are connected to the closing profiles 10b, 10c and/or in the vicinity thereof to the frame structure 2. As indicated in FIG. 8C, on one side of the hatch insert, a wall panel 88 is fastened to the cross-member 86, the vertical struts 16a and/or the stiffening elements 14a. Attached to both sides of the hatch insert, the wall panels 88 adapt the design of the hatch insert to the building wall surrounding it.

FIG. 8D is a side view of the hatch 80 and the guide rail system comprising the guide rail 82 and the electromechanical drive 84. From this, and in conjunction with the horizontal cross-section shown in FIG. 8E, it is clear that the hatch 80 is displaceable between the cross-members 86.

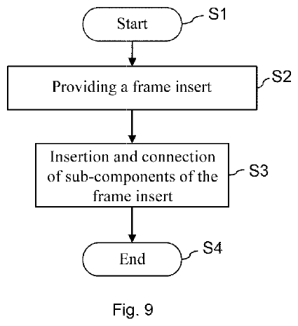

As mentioned above, the building wall module system 1 can be adapted as required to requirements for the use of rooms and/or the life circumstances of the occupants, which change over time. The frame structure 2 is prepared for an application in which the (expandable) sliding door 4 is inserted into the frame structure 2 and used, and can be already installed as such in the building. With the understanding of the basic embodiments of the casing insert 22 described above and their functions, in the following an exemplary method for adapting the building wall module 1, proceeding from the frame structure 2 described in FIG. 1A-FIG. 1H is described in conjunction with FIG. 9. The method shown in FIG. 9 begins with a step S1 and ends with a step S4. A person skilled in the art will recognize that the division into these steps is by way of example, and that one or more of these steps may be divided into one or more sub-steps.

In order to adapt the building wall module 1, one of the aforementioned frame or casing inserts 22 can be selected. In a step S2 the (selected) frame or casing insert 22 is provided. The frame or casing insert 22 is to be inserted into the through-passage region 6 and, from there, is to be connected to the frame structure 2 in accordance with a step S3. The casing insert 22 provided comprises a plurality of sub-components, each having at least one connecting element, by means of which the respective sub-component can be connected to the frame structure 2, following positioning with respect to one of the mentioned closing profile pairs 10a, 10b, 10c, a sequence being specified for the positioning and connecting. A person skilled in the art will recognize that the selection of the casing insert 22 also specifies its sub-components (e.g. casing elements 22a, 22b, 22c or struts 16a, reinforcing elements 14a, and base profile 19a); in order to avoid repetition, with respect to the sub-components reference is made to the above-described embodiments of a casing insert 22.

When the casing insert is provided in such a way, the sub-components will be inserted and connected according to the specified sequence. The insertion of the sub-components of the through-passage insert is described e.g. in conjunction with FIG. 2E-FIG. 2H. There, firstly the upper casing element 22c is inserted into the frame structure 2 in which the slots 27 of the casing element 22c are aligned with the bolts 25 of the closing profile 10c and the casing element 22c is pushed upward, so that the bolts 25 move into the slots 27. Then vertical casing elements 22a, 22b are inserted by aligning their slots 27 with the bolts 25 of the closing profiles 10a, 10b. Here, the casing element 22c is pressed upward, as a result of which the spring elements 23 are pressed against surfaces of the closing profile 10c and are compressed, so that the corner connector 21 can be positioned over the receptacle of the (now vertically standing) casing element 22b. When the casing element 22c is then released, the spring elements 23 relax and press the casing element 22c downwards, as a result of which the corner connector 21 enters the receptacle of the casing elements 22a, 22b.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A building wall module system comprising:
a frame structure having predefined width, height and depth dimensions, the frame structure including a first strut structure extending in a first plane and a second strut structure extending in a second plane that is parallel to the first plane and is at a specified distance therefrom in a direction of the depth dimension, the first and second strut structures forming a free space between the first and second planes, the frame structure having a wall side region, a wall shell region, a through-passage region between the wall side region and the wall shell region, and a guide rail system extending above the through-passage region;
wherein each of the first and second strut structures has on the wall side region, adjacent to the through-passage region, a first lateral closing profile pair, and has on the wall shell region, adjacent to the through-passage region, a second lateral closing profile pair, and has an upper closing profile pair, adjacent to the through-passage region, connecting the first and second lateral closing profile pairs at right angles, the second lateral closing profile pair and the upper closing profile pair each having a passage adapted to receive a sliding door; and
wherein the guide rail system has a guide rail arranged in an upper region of the frame structure and extending in parallel with the upper closing profile pair, the guide rail adapted to displace the sliding door between a closed position, in which the sliding door closes the through-passage region and engages against the closing profile pair, and an open position in which the sliding door completely or partially releases the through-passage region and is displaced into the free space in the wall shell region via the passage in the second lateral closing profile pair; and
a casing insert having a plurality of connecting elements connecting the casing insert, inserted into the through-passage region, to the frame structure, and as the casing insert is removed from the through-passage region, the connecting elements release the casing insert from the frame structure.

17. The building wall module system according to claim 16 wherein the casing insert includes a first casing element adapted to be inserted on the first lateral closing profile pair, a second casing element adapted to be inserted on the second lateral closing profile pair, and a third casing element adapted to be inserted on the upper closing profile pair, each of the first, second and third casing elements having at least one of the connecting elements.

18. The building wall module system according to claim 17 wherein each of the at least one connecting elements includes a slot adapted to receive an associated bolt element arranged on the frame structure.

19. The building wall module system according to claim 18 wherein each of the at least one connecting elements includes a securing element fixing the associated bolt element inserted into the slot.

20. The building wall module system according to claim 17 wherein the third casing element has a resilient element on an inner surface pressing the third casing element toward the first and second casing elements with the casing insert inserted in the through-passage region.

21. The building wall module system according to claim 20 wherein the resilient element is a spring element.

22. The building wall module system according to claim 17 wherein the casing insert is a through-passage insert with the first, second and third casing elements together forming a masking frame having an outer surface that surrounds the through-passage region along the closing profile pairs and covers each of the closing profile pairs at least towards the through-passage region, the outer surface of the masking frame being flat.

23. The building wall module system according to claim 17 wherein the casing insert is a shelving insert that closes the through-passage region, the shelving insert having a rear wall connected to the first, second and third casing elements and at least one shelf accessible from a side of the shelving insert opposite the rear wall.

24. The building wall module system according to claim 17 wherein the casing insert is a swing door insert having a swing door and fittings, the swing door being movable to block and release the through-passage region, and the swing door being pivotably connected by the fittings to the first and second casing elements.

25. The building wall module system according to claim 17 wherein the casing insert is a sliding door insert including a sliding door, the second casing element having a vertical feedthrough through which the sliding door is guided into the wall shell region between the first and second strut structures, the third casing element having a horizontal feedthrough through which the sliding door is connected to the guide rail system and along which the sliding door is displaced.

26. The building wall module system according to claim 16 wherein the casing insert is a pass-through insert having a pass-through formed therein and a wall part, pass-through insert filling the through-passage region except for the pass-through, the wall part having a cross-member arranged at a fixed height in a direction of the height dimension, a base element and vertical struts, the vertical struts extending in two parallel planes, corresponding to the first and second planes of the first and second strut structures, between the base element and the cross-member.

27. The building wall module system according to claim 16 wherein the casing insert is a wall insert that fills and closes the through-passage region, the wall insert having vertical struts, stiffening elements and a base profile, the vertical struts extending between the base profile and the upper closing profile pair in two parallel planes corresponding to the first and second planes of the first and second strut structures.

28. The building wall module system according to claim 27 wherein the stiffening elements have flanges adapted to be connected to the frame structure, wherein the base profile has flanges at lateral ends adapted to be connected to the frame structure, and wherein the vertical struts are adapted to be connected at lower ends to the base profile and at upper ends to the upper closing profile pair.

29. The building wall module system according to claim 16 wherein the casing insert is a hatch insert having a wall part and a hatch in an opening in the wall part, the hatch being movable between an open state of the opening, thus opening a part of the through-passage region, and a closed state in which the opening is blocked, the hatch insert in the closed state of the hatch entirely filling the through-passage region.

30. The building wall module system according to claim 29 wherein the hatch is one of a horizontally displaceable sliding hatch, a vertically displaceable sliding hatch, a horizontally pivotable flap and a vertically pivotable flap.

31. The building wall module system according to claim 30 including an electromechanical drive that automatically opens and closes the hatch.

32. A method for adapting a building wall module system according to a use requirement, the method comprising the steps of:
providing the frame structure and the casing insert according to claim 16;
installing the frame structure in a building;
inserting the casing insert into the through-passage region of the frame structure;
connecting the casing insert to the frame structure using a plurality of sub-components of the casing insert each having at least one connecting element adapted to connect to an associated sub-component of the frame structure; and
performing the inserting and connecting steps according to a specified sequence.

33. The method according to claim 32 wherein the specified sequence includes inserting the first casing element on the first lateral closing profile pair, inserting the second casing element on the second lateral closing profile pair, and inserting the third casing element on the upper closing profile pair, wherein the third casing element is inserted first by pushing upward thereby compressing at least one spring element, the at least one spring element releasing after the insertion of one of the first casing element and the second casing element so that the third casing element presses against the one of the first or second casing elements.

34. The method according to claim 32 wherein the casing insert is one of a through-passage insert, a pass-through insert, a shelving insert, a swing door insert, a sliding door insert, a wall insert and a hatch insert.
